(19) United States
(12) Patent Application Publication
(10) Pub. No.: US 2026/0256121 A1
(43) Pub. Date: Sep. 3, 2026

(54) METHODS AND APPARATUS FOR CREATING EGG MODELS

(71) Applicant: BOARD OF EDUCATION OF THE VOCATIONAL SCHOOLS IN THE COUNTY OF BERGEN, Paramus, NJ (US)

(72) Inventors: Muhammad El-Sherbiny, Fort Lee, NJ (US); Carlos A. Nodarse, Rutherford, NJ (US)

(73) Assignee: BOARD OF EDUCATION OF THE VOCATIONAL SCHOOLS IN THE COUNTY OF BERGEN, Paramus, NJ (US)

(21) Appl. No.: 19/350,760

(22) Filed: Oct. 6, 2025

Related U.S. Application Data
(60) Provisional application No. 63/765,369, filed on Feb. 28, 2025.
(60) Provisional application No. 63/784,717, filed on Apr. 7, 2025.

(51) Int. Cl. A01K 45/00; A01K 41/02; A01K 41/04; A01K 43/00

(52) U.S. Cl. CPC A01K 45/007; A01K 41/023; A01K 41/04; A01K 43/00

(57) ABSTRACT

Methods and apparatus for making egg models and monitoring eggs, and more specifically to hyper-customizable egg models for hard-shelled eggs to make them more accessible for various applications.

### CROSS-REFERENCE TO RELATED APPLICATIONS

This application claims priority to and benefit of U.S. Provisional Patent Application No. 63/765,369, filed Feb. 28, 2025, and U.S. Provisional Patent Application No. 63/784,717, filed Apr. 7, 2025, the disclosures of which are incorporated herein by reference in their entireties.

### BACKGROUND

### Field of the Disclosure

The present disclosure relates generally to methods and apparatus for making egg models and monitoring eggs, and more specifically to hyper-customizable egg models for modification of hard-shelled eggs to make them more accessible for various applications.

### BRIEF DESCRIPTION OF THE DRAWINGS

FIGS. 1A and 1B are perspective views of a device for creating a window in an avian egg according to the present disclosure.

FIGS. 2A, 2B, 2C, 2D, 2E and 2F are views of other devices for creating a window in an avian egg.

FIGS. 3A, 3B, 3C and 3D show cap designs.

FIGS. 4A and 4B show caps with tape.

FIG. 5 is a table showing cap testing data.

FIGS. 6A, 6B and 6C are diagrams showing theoretical in-situ dye ingress testing.

FIG. 7 is a graph showing intensity distributions of eggs with different coverings.

FIG. 8 is a perspective view of an imaging incubator according to the present disclosure.

FIGS. 9 and 10 are views of the incubator with LEDs on arms.

### SUMMARY

A method and apparatus for creating egg models is disclosed and includes a method and apparatus for creating windows in eggs, monitoring eggs, accessing eggs, assessing eggs, incubating eggs and imaging eggs.

### DETAILED DESCRIPTION

The present disclosure relates to egg models, as discussed in detail below. More specifically, the present disclosure relates to “hyper-customizable” egg models, a new term that denotes the systematic modification of hard-shelled eggs for enhanced accessibility and versatility in various applications. The modification process includes drill-based or laser-based techniques to create precise air-cell shell windows. The present disclosure also relates a self-healing closure mechanism through egg caps, which provides resealable access to the egg environment. Additionally, an incubator is disclosed for continuous monitoring of these hyper-customizable egg models during incubation.

Avian eggs are deeply integrated into our society, as evidenced by the per capita consumption of approximately 285 food-grade chicken eggs per person in the United States in 2023. Beyond their traditional role as a food source, eggs offer significant potential for a wide range of applications. These include, but are not limited to, ovo sexing, the development of transgenic animals, enhancements to choriollantoic membrane (CAM) assays, virus and biomolecule production for vaccines, and the nutritional fortification of unfertilized eggs.

### CNC Drill Ablation, Suction, and Covering for the Creation of Avian Air Cell Windows

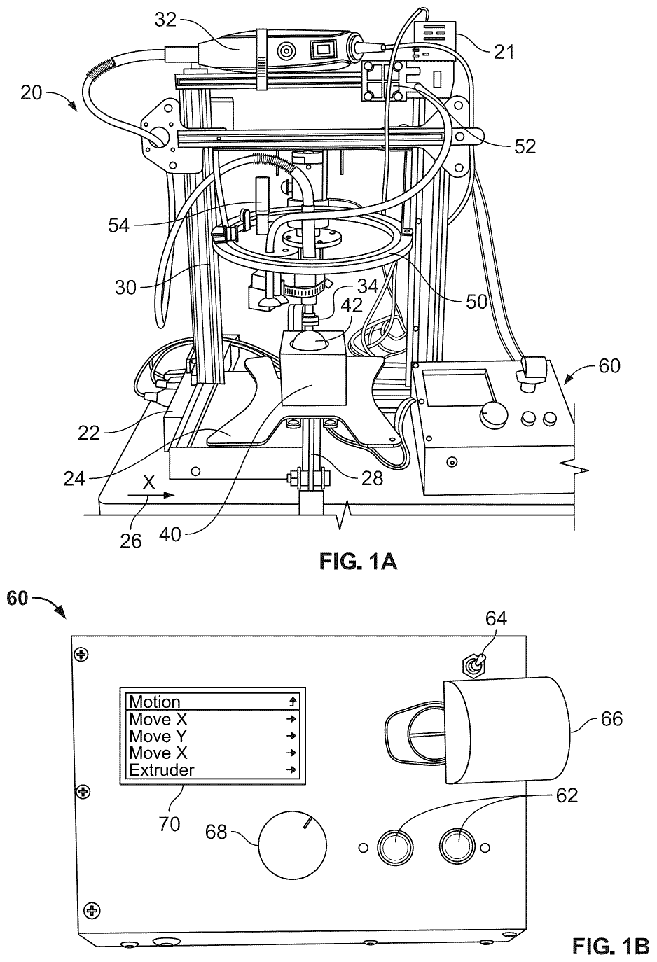

A CNC drill-based apparatus was used for creating standardized windows in avian eggs, thereby enabling repeated, sterile in-ovo interventions, herein referred to as a Drill-Based Windower for Avian Eggs (DWAVE). As shown in FIGS. 1A and 1B, the DWAVE repurposed an Ender 3 3D printer by using vertical (z-axis) and lateral (y-axis) motions. The conventional x-axis was substituted with a ball-bearing carousel mechanism. The carousel sequentially presents eggs to three integrated modules: a drilling station, a suction-based decapping station, and an automated covering station. This process ablates a precise section of the eggshell, removes the residual shell cap, and then applies an adhesive covering. This can be done in a continuous, automated cycle. The drill descends upon an egg and creates a window, debris and the residual eggshell is removed, and a self-healing tape covering is applied.

Referring to FIGS. 1A and 1B, the drilling device 20 has a power supply 21, a system on/off control 22, a base 24, an x-axis 26, y-axis stepper belt 28, a z-axis stepper shaft 30, a rotary drill attachment 32, a drill 34, and metal remover. An egg memory foam egg holder 40 accommodates variably sized eggs 42. A carousel 50 was mounted onto the y-axis 28 of the device 20, the carousel 50 rotating and divided into three stations that can be magnetically held in place. These stations include a drill 34 or Dremel tool, which could include a flexible shaft, fitted with, for example, a ⅝ inch ceramic drill bit, a vacuum pump 52 attached to a suction arm, and a hydraulic tape applier (which was made from syringes and memory foam) 54. The controls are the on-board controls from the Ender 3D printer, however the CNC component could be custom configured using an independent board. The depth of movement of the drill/Dremel tool or drill can be programmed. The device can be made in a dedicated integrated form.

The rotary drill attachment was an ENGINDOT Rotary Tool Kit, with a Milwaukee ⅝″ Diamond Drill Bit. A stepper motor and z-axis stepper belt on z-axis shaft 30 and lead screw provide controlled vertical movement. Although the theoretical resolution of the z-axis may be extremely fine (with microstepping on the order of submicron increments), practical positioning accuracy is typically around 0.1 mm due to mechanical tolerances and inherent system vibrations. The y-axis stepper belt 28, used for lateral positioning, works in concert with a memory foam egg holder 40 that stabilizes eggs 42 of various sizes. The egg holder was constructed using memory foam derived from a cushion and was cut to a size. In the center of the cut foam, a divot was formed to securely hold an egg. In this arrangement, the computer numerical control (CNC) is achieved either through the printer's built-in firmware or via a custom-designed PCB with position sensors, which could further enhance repeatability and accuracy.

The egg holder 40 was secured to the base 24 with adhesive. A circular metal plate was modified and used as a carousel 50 to integrate tools, with holes drilled along a 2.5-inch radius to fit half of the circle due to spatial constraints. The plate enabled tool rotation. A central hole was drilled for a motor with a chuck, with stabilization provided by bending L-shaped brackets and securing them to the carousel holder. The DC motor was clamped to the carousel with hose clamps for added stability. The rotary tool 32 and vacuum pump 52 were mounted onto the top bar of the printer, with a secondary power supply installed to meet additional power needs. Referring to FIG. 1B, the custom control panel 60 was 3D-printed and extended to include analog controls, switches 62 for the motor and 64 for the vacuum pump, and a hydraulic control 66. Dial 68 provides for axis control and display 70 displays information. Electrical connections were made by soldering wires to connect the components to the motor controller.

In the drilling station, a rotary tool outfitted with a drill bit is mounted on the z-axis carriage. As the z-axis descends, the drill bit ablates a circular section of the eggshell, typically targeting, for example, a diameter of approximately 16 mm. This controlled ablation removes only the outer shell layers while preserving the inner air-cell membrane. The CNC system is programmed and using position sensors and time of flight (TOF) sensors to halt the drilling process just before membrane contact, thus preventing accidental puncture and ensuring a high rate of success.

Because the drilling process does not remove the entire shell fragment at the window's periphery, a residual shell cap remains attached to the egg. A dedicated decapping station, located immediately downstream on the carousel, employs a vacuum pump with a suction-cup nozzle to generate localized negative pressure. This suction mechanism gently detaches and removes the residual shell cap, thereby clearing the window area while maintaining the integrity of the inner membrane.

Following decapping, an adhesive covering material, typically a self-healing silicone-based tape, is applied over the window. The cover can be applied hands-free via hydraulic or pneumatic pressure to uniformly cover the window. The covering device is designed to stamp the adhesive in a consistent and reproducible manner, sealing the window against environmental contamination and excessive water loss. Although the initial prototype uses off-the-shelf components (such as modified syringes and foam pads) for actuation, further enhancements using a custom PCB with integrated force sensors can optimize pressure control and alignment.

The overall architecture abstracts the core functions of the DWAVE: using the z-axis for precise vertical motion, substituting the conventional x-axis with a rotating carousel for lateral repositioning, and synchronizing the sequential operations of drilling, decapping, and covering. This integrated design not only reduces manual handling and the risk of contamination but also ensures that each egg is processed in a repeatable, high-throughput manner.

Testing of the prototype was conducted over a 50-minute period, during which approximately 70 eggs were processed with a measured success rate exceeding 90% in preserving the inner membrane, demonstrating that the integrated operation-comprising CNC-controlled drill ablation, effective removal of shell fragments, and uniform covering application—yielded consistent, reproducible window dimensions and maintained the internal environment of the eggs. This proof-of-concept validates the technical approach and highlights opportunities for further refinement, such as integrating closed-loop control systems and custom PCBs for enhanced precision.

### Rotation-Based, Horizontal Laser Ablation for the Creation of Variably Sized Air-Cell Windows (S-WAVE and Q-WAVE)

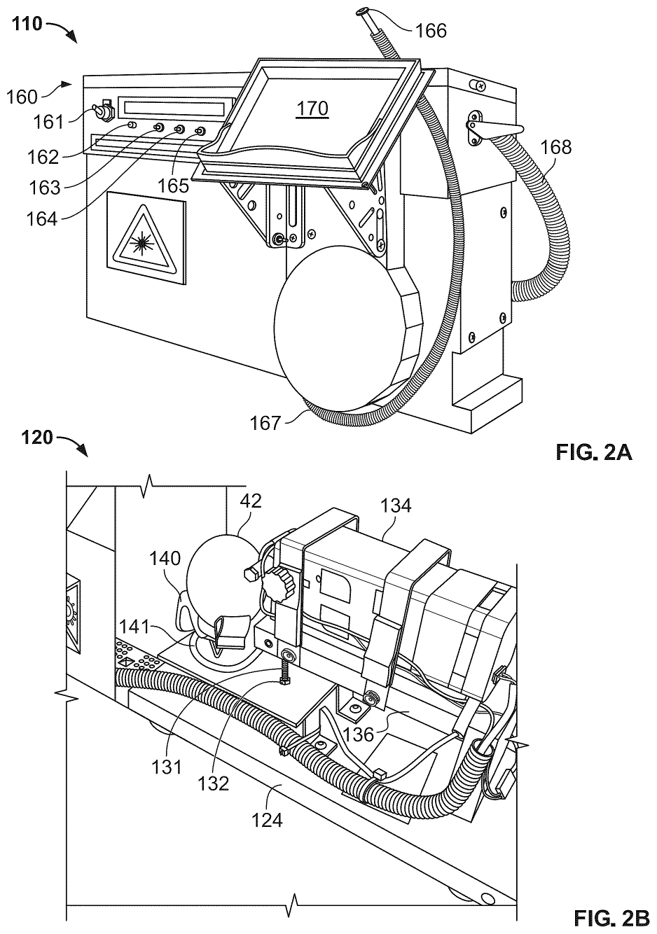

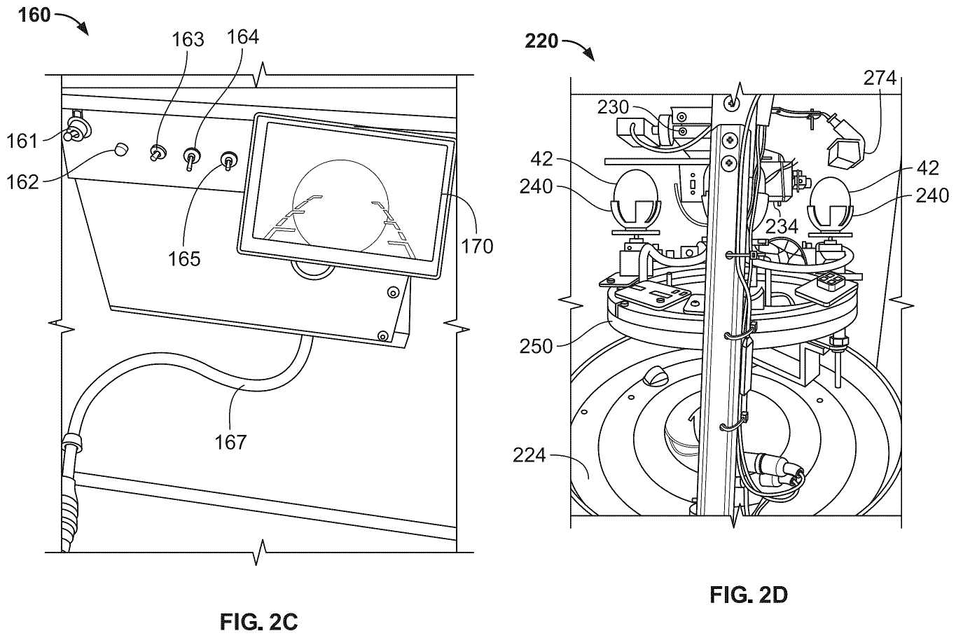

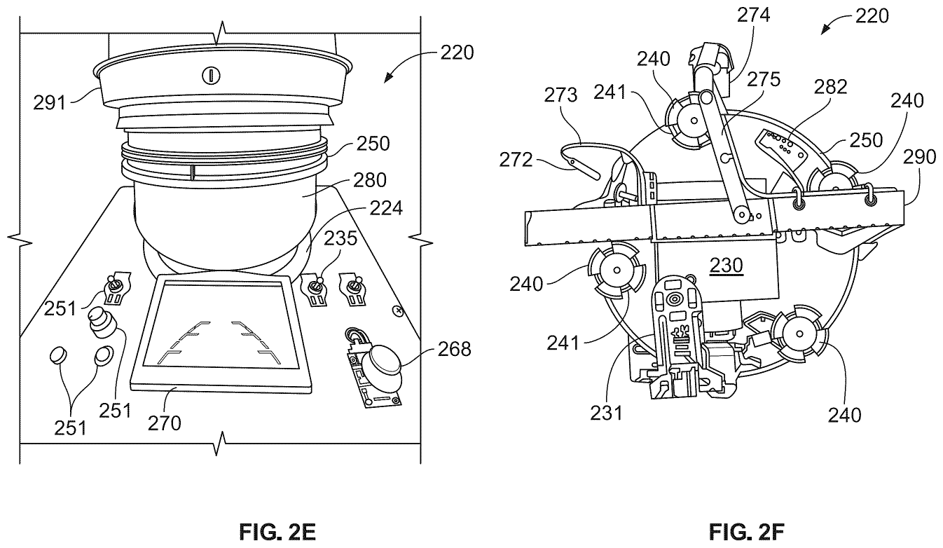

A rotation-based, horizontal laser ablation system, herein referred to as WAVE (Windower for Avian Eggs), includes a Single WAVE (S-WAVE) (FIGS. 2A-2C) and a Quadruple WAVE (Q-WAVE) (FIGS. 2D-2F). These devices produce variable-sized windows in the eggshell near the air cell by orienting a laser beam horizontally relative to the egg's surface. The horizontal configuration minimizes the risk of penetrating the inner air-cell membrane, as the beam is maintained parallel to the egg. In addition, it is contemplated that a similar horizontal arrangement could be adapted for a drill or mechanical abrading tool; however, the present disclosure focuses on laser ablation due to its non-contact and controlled thermal characteristics.

### The S-WAVE Accommodates a Single Egg While the Q-WAVE Accommodates Four Eggs at a Time

FIG. 2A shows an outer casing 110 and display screen 170 for an S-WAVE device in a portable configuration.

As shown in FIGS. 2A and 2C, a control panel 160 is on the exterior of case 110. The control panel 160 includes laser on/off switch 161, laser indicator LED 162, nest rotation switch 163, laser diode switch 164 and display screen on/off switch 165. A remote laser off switch 166 is attached via cable 167. A shielded power cord 168 is also shown. Referring to FIG. 2B the S-WAVE processes one egg at a time. As shown in FIG. 2B, the base 124 can be constructed from a stainless steel sheet, for example, a sheet approximately 36″×36″ in size with a thickness of ⅛″. The base supports a laser absorption barrier, which can be fabricated from a section of steel (for example a 6″×3″ section having approximately ⅞″ thickness) to minimize stray laser reflections. A PVC board (for example, about 11.5″×3″×0.5″) is utilized to support the laser module and the accompanying sliding mechanism.

In the S-WAVE prototype, a Class IV laser module 134 operating, for example, at 445 nm and rated at 10 W, is mounted horizontally on bolts 131 with nut 132 bearing against a platform. The rail assembly 136 can be fabricated by 3D printing and permits fine vertical adjustment of the laser relative to the egg's surface. Other laser specifications can be employed. The height of the laser can be set manually by two adjustment screws, thereby controlling the ablation depth to achieve window diameters in the range of approximately 10 mm to 24 mm. The positioning of the laser with respect to the egg can be automated. The egg 42 is secured in a nest 140 (which could be 3D-printed to approximately 1.75″×1.75″×1.25″, and covered with foam) that is mounted on a rotating platform 141 controlled with a micro servo. An Arduino UNO microcontroller can control the servo to rotate the egg steadily in front of the laser 134, ensuring that the ablation occurs uniformly around the shell circumference.

An electronic container, which can be integrated with the S-WAVE assembly, can house the control components necessary for system operation. The container can be constructed from stainless steel and can include elements such as an Arduino UNO, a 9-volt battery clip, a 3-volt battery holder, and a laser module controller. Additionally, three mini toggle switches, an LED activation indicator, and a push-button safety switch are included. A panel (such as a 7-inch LCD panel having a size of approximately 6″×3″) provides real-time feedback from an onboard camera that monitors the laser ablation process. Preliminary testing of the S-WAVE prototype indicated a processing throughput of about 54 eggs per hour with a success rate of approximately 94% in preserving the inner membrane.

It is within the scope of the present disclosure to incorporate closed-loop feedback using integrated position sensors and a custom-designed PCB. Such enhancements would further improve the precision and reproducibility of the ablation process.

### Q-WAVE Frame Exterior Assembly (FIG. 2D-2F)

The Q-WAVE systems utilizes a servo-driven carousel to rotate the egg while a laser beam, mounted on a scissor-lift assembly, is directed horizontally. The carousel replaces the conventional x-axis motion by providing low-friction, continuous rotation, while the y and z axis of the modified 3D printer provide lateral positioning and controlled vertical movement, respectively. This arrangement ensures that the ablation process is precisely executed along a predetermined path that is parallel to the inner membrane, thereby enhancing reproducibility and accuracy.

The Q-WAVE 220 extends the horizontal laser ablation approach to process multiple eggs, such as four eggs, concurrently. The advantage of a laser over a drill is non-contact, reduced vibration and greater precision. In this system, an enclosure can surround the apparatus. A 5-gallon metal bucket can serve as the enclosure 280. A ball-bearing carousel 250 can be mounted inside the bucket and above base 224.

The carousel supports four egg nests 240, each of which is driven by an individual micro servo. Each nest is designed similarly to that in the S-WAVE, ensuring consistent egg positioning.

The laser module 234 is mounted on a scissor-lift mechanism 230. The scissor lift could be a LabScissors Jack, Laboratory Support Jack Platform with Blade Hand Wheel, available on Amazon. com. A servo drive can be connected to the hand dial and operated with a thumb joystick such as product number 512 from Adafruit Industries, LLC. In the Q-WAVE, vertical adjustment of the laser may be semi-automated via a scissor lift attached to a servo; this mechanism allows for finer control over the ablation depth for each egg being windowed in a sequential manner. Any number of eggs 42 could be positioned on a carousel, or other positioning device, e.g. a continuous line. The egg is moved into position in front of a laser and the positioning device dwells while the laser ablates the egg.

The electronic control in the Q-WAVE is distributed among multiple microcontrollers. A primary Arduino UNO (or an Arduino Feather integrated onto the carousel) and two Arduino Nano microcontrollers (each with custom PCB boards) manage system functions. One Nano board handles safety protocols and laser activation, while the other controls the scissor-lift mechanism via a thumb joystick 268. A DC motor, coupled with an adjustable speed controller, rotates the carousel; the motor is mounted using a shaft adapter and is attached to the carousel via a 3D-printed C-bracket. Additional components include an LCD panel 270 (which could be, for example, approximately 5″×3.25″), toggle switches 235 for laser activation and carousel controls 251, and safety features such as a red push-button that deactivates the laser immediately if necessary.

Testing of the Q-WAVE prototype demonstrated that processing multiple eggs concurrently yields cumulative throughput that is competitive with single-egg systems while maintaining inner membrane integrity in over 90% of cases. The design also incorporates provisions for thermal management-continuous rotation minimizes localized heat build-up-and uses automobile backup camera 272 (a semi-rigid endoscopic camera) on adjustable arm 273 (FIG. 2F) to ensure proper alignment and monitoring of the ablation process.

FIG. 2F shows the Q-Wave device 220 with carousel 250 from above. A plurality of egg nests 240 are shown on the carousel 250 on rotating platforms 241. Also shown is a scissor lift 230 and scissor lift servo 231. Camera 272 shows egg positioning and camera 274, on camera boom 275, can show the egg opening. Main bracket 290 supports main assembly 291 (FIG. 2E). Servo 282 on the carousel is shown.

Both the S-WAVE and Q-WAVE devices are presented in a modular format, allowing individual subsystems (such as the laser module, servo-driven egg nest, and electronic control assembly) to be replicated or modified as needed. In the Q-WAVE, an Arduino feather was attached onto the carousel to prevent tangling. Carousel rotation was controlled by a DC speed controller. As such, the speed of carousel rotation is adjustable, although a speed of approximately 30 rpm, allows the use of discrete push button positioning of each egg nest (basket) in front of the laser. Once in front of the laser, the servo mounted to the nest can adjust rotation speed through the Arduino controller, although a speed of approximately 40 rpm allowed for reliable ablation of the eggshell in approximately 45 seconds.

Similar efficiency testing as conducted for the Single WAVE system was performed with the quadruple system, focusing on the ability to process multiple eggs concurrently. The efficiency and effectiveness of the laser windowing in the Quadruple WAVE were used as a basis of comparison to the Single WAVE laser windowing and the handheld drill windowing approach.

### 3D Printed Self-Healing Transparent Air-Cell Caps (STACC)

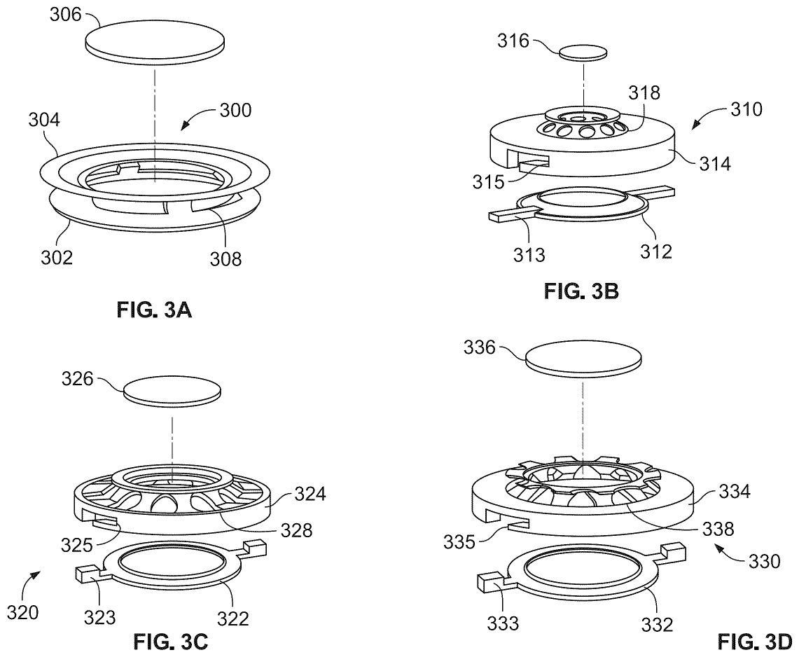

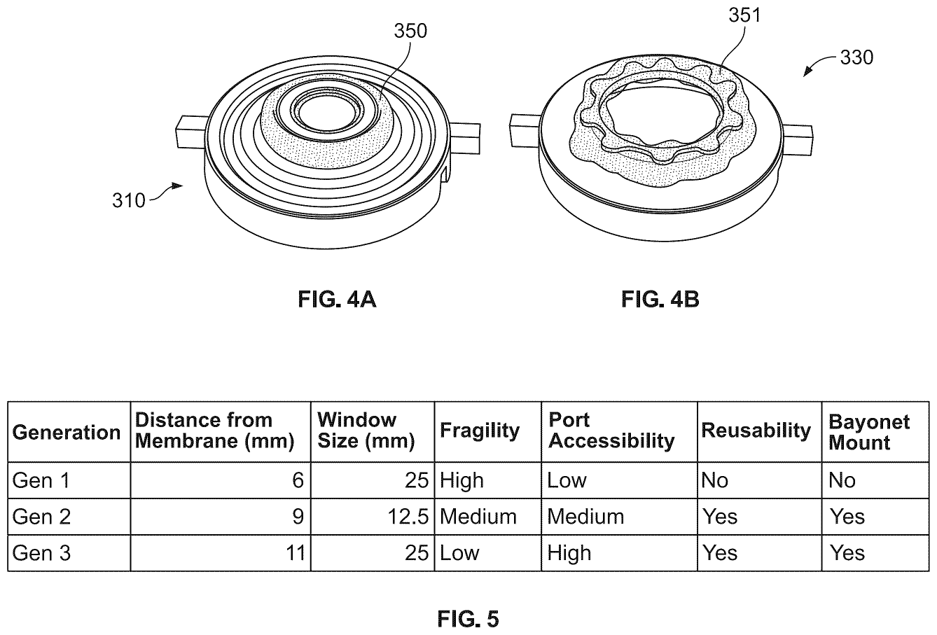

A 3D Printed Self-Healing Transparent Air-Cell Cap (STACC) system is designed to provide a clear, resealable window over a pre-formed air-cell opening in an avian egg as shown in FIGS. 3A, 3B, 3C and 3D, and in FIGS. 4A and 4B, to maintain a sterile internal environment while allowing repeated access for in-ovo imaging and intervention.

The STACC system can be formed of a unitary structure as shown in FIG. 3A (generation 1) or it can be comprised of a disposable base and a reusable cap as shown in FIG. 3B (generation 2), 3C and 3D (both generation 3). These caps can be 3D printed or otherwise manufactured from a suitable material such as molded from plastic. As shown in FIG. 3A, the cap 300 has a base 302, which is attached to an egg, and an upper ring 304 which supports a transparent slide 306 through which an opening in an egg can be viewed. Apertures 308 allow for the egg to be accessed through the cap. The cap 300 can be permanently attached to the egg. FIGS. 3B, 3C and 3D show caps 310, 320 and 330 having two components with a base 312, 322 and 332, which can be disposable, affixed to the egg, removably or permanently, surrounding an opening, and a reusable upper ring 314, 324 and 334, which supports transparent coverslips 316, 326 and 336, and which attaches to the base via a bayonet lock mechanism comprising extension legs 313, 323 and 333 that can be received slots 315, 325 and 335 and twisted to lock. This connection ensures proper alignment and an airtight seal that is capable of withstanding multiple cycles of removal and reattachment. Each upper ring includes apertures 318, 328 and 338 for accessing the egg through the cap.

The reusable portion of the cap is engineered with a hyperboloid shape, a design chosen for its concave, walled sides, which allow for the self-healing portion of the cap to be penetrated laterally, while also having an aperture which can allow simultaneous viewing. The curvature enables a broad, circular viewing area that is positioned at the vertical midpoint of the cap. The circular window is dimensioned to match the underlying air cell, thereby maximizing the observable area while minimizing the distance to the inner air cell membrane.

Within the viewing area of the cap, a transparent glass coverslip-typically, for example, about 25 mm in diameter-is securely mounted. The cap is designed with a peripheral lip that holds the coverslip in place, ensuring that it remains flush with the cap surface. This configuration minimizes any gaps at the interface, thereby reducing the risk of contamination and ensuring consistent, uniform light transmission for accurate imaging.

The STACC further utilizes self-fusing silicone tape applied around the access ports. As shown in FIGS. 4A and 4B, The cap 310 shown in FIG. 4A corresponds to the cap shown in FIG. 3B and shows tape 350 applied over ports (not shown). Likewise, the cap 330 shown in FIG. 4B corresponds to the cap shown in FIG. 3D and shows tape 351 applied over ports (not shown). These ports are designed to allow sterile interventions and are engineered to reseal automatically after puncture. Resealability testing was conducted by inverting the cap and filling it with dye over a white cloth; even after up to 10 punctures using a 14-gauge needle, the cap maintained its seal with no observable leakage. These results are set forth in FIG. 5. This performance indicates the reliability of the self-healing property under conditions simulating repeated access.

The overall design of the STACC system combines a modular, 3D-printed structure with proven self-healing materials to deliver a functional and reproducible covering for windowed eggs. The integration of a hyperboloid cap shape, a securely mounted transparent coverslip, and self-fusing silicone tape for resealing provides a clear, stable window for continuous monitoring of the egg's internal environment.

### In-Situ Covering Integrity Assessment Via Dye

An in-situ covering integrity assessment method based on a dye ingress assay can be used to evaluate the self-healing performance of commercially available self-amalgamating silicone tape when employed as a covering for air-cell windows in avian eggs. This assay can quantify the degree of liquid penetration through the covering without the need for experiments on fertile eggs, thereby avoiding complications such as relative water loss and potential bacterial invasion.

In conventional container closure integrity tests, dye ingress is used to determine the effectiveness of a seal by submerging a container in a dye solution. However, when applied to avian eggs, direct submersion in dye proved unsuitable; initial tests showed that the high concentration gradient of the dye led to an excessive influx of liquid, causing eggs to swell and ultimately burst. To overcome this, the assay employed a modification involving a physical “scaffold.”

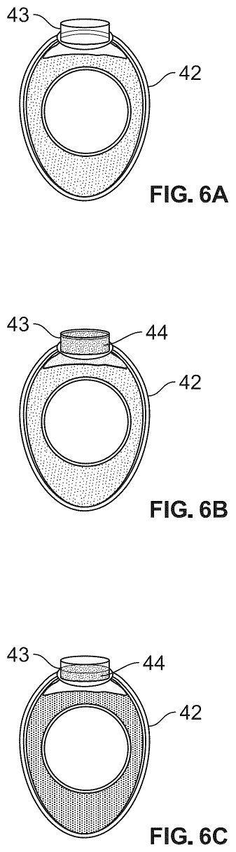

The term “scaffold” refers to a custom-fabricated, rigid framework that is affixed to the egg's surface around the windowed area. The scaffold can be constructed by cutting disposable syringes into uniform ring segments, such as, for example, 25 segments, each measuring, for example, approximately 10 mm in height and 16 mm in diameter. These ring segments can be hot-glued onto the blunt pole of the egg, effectively creating a shallow, defined well that surrounds or aligns with the boundaries of the window. This physical structure confines the dye to the specific area of interest, ensuring that any dye ingress measured is attributable solely to the integrity of the covering. FIG. 6A is a diagram of an egg 42 with a well 43, thereon. FIG. 6B shows a dye 44 added to the well. FIG. 6C shows dye diffused into the egg with any remaining dye in the well. Theoretical dye ingress is shown over time.

Prior to testing the dye ingress on windowed eggs, a standard curve can be established to quantitatively relate dye concentration in the albumen to optical absorbance at 640 nm, the peak wavelength for McCormick Blue No. 1 dye. This relationship is grounded in the Beer-Lambert Law, which is mathematically expressed as A=ε·c, where A is the measured absorbance, ε is the molar absorptivity coefficient, c is the concentration of the dye.

To generate the standard curve, a series of 0.5×serial dilutions is prepared in triplicate. The process begins by mixing 300 μL of albumen with 300 μL of dye, and then performing serial dilutions to create a range of dye concentrations. Each dilution is plated into individual wells of, for example, a 96-well plate, and the absorbance is measured using a microplate reader. Experimental data typically yield a high correlation coefficient (R²>0.99), confirming the reliability of this linear relationship for subsequent analyses.

Following the establishment of the standard curve, eggs were prepared in three groups: normal unmodified eggs (serving as controls, divided into treated and untreated subsets), windowed eggs left uncovered, and windowed eggs that were sealed with a covering composed of a specified ratio of silicone polymer (SP) to regenerated cellulose (RC).

Once the eggs have been windowed, and where applicable, covered, a 14-gauge syringe needle is used to create three equidistant perforations in the covering material. This step is intended to simulate repeated access and challenge the self-healing properties of the covering, allowing for a comparison between the integrity of the covering on perforated versus non-perforated eggs.

After perforation, the custom scaffold is affixed to each egg. The scaffold serves to restrict the dye application to the windowed area. It is aligned with the periphery of the window and secured with additional hot glue to create a watertight seal around the area of interest.

The eggs, now equipped with scaffolds, are arranged in a carton holder with each group set in its own row to facilitate orderly processing. Laboratory equipment—including a micropipette, blue dye solution, scissors, a sieve, parafilm, beakers, and disposable cups—is prepared in the test area to maintain a controlled experimental environment.

For each egg, 500 μL of blue dye is added into the well created by the scaffold, and the well is immediately covered with parafilm to prevent evaporation and contamination. The eggs are then left undisturbed for a period of 60 minutes to allow the dye to diffuse through any breaches in the covering and into the underlying albumen.

Addressing whether a self-healing polymer prevents dye ingress compared to normal egg groups, regardless of whether or not the covering was perforated with a needle, was done as follows:

After the incubation period, the parafilm is removed and any excess dye is decanted into a waste beaker. Each egg is then gently cracked into a sieve suspended over a disposable cup, and a metal stirrer is used to mix the diffused dye thoroughly into the albumen. Care is taken to avoid rupturing the yolk membrane as this could introduce confounding variables. Once a sufficient volume (at least 100 μL) of dyed albumen is collected, the process is repeated for all eggs, with the sieve and stirrer being washed between samples. From each sample 100 μL of the dyed albumen is transferred into a designated well of a 96-well plate. Using 5 more eggs that were untreated, micropipette 100 μL of undyed albumen on the 96-well plate. For baseline comparison, 100 μL of undyed albumen is also collected from five untreated eggs and plated similarly. The plate is then analyzed using a microplate reader set to 640 nm, and the absorbance values for each well are recorded. These values are compared against the standard curve, thereby providing a quantitative measure of the amount of dye ingress. This method offers an inexpensive and efficient means to assess the integrity of the covering in an in-situ context, without necessitating the use of fertile eggs or the direct measurement of bacterial contamination.

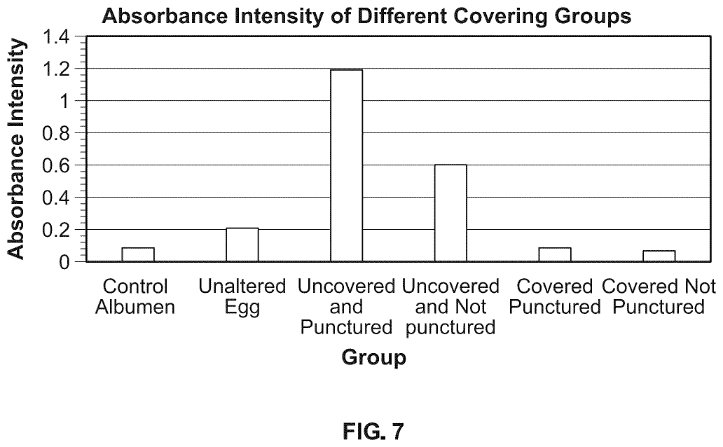

FIG. 7 shows absorbance intensity distribution between different coverings, with uncovered eggs having the highest values. Each line represents an average of five samples. This graph also demonstrates the effects of puncturing an egg membrane integrity, with the punctured uncovered group having drastically higher absorbance intensity or in other words much more dye ingress. FIG. 7 illustrates the absorbance intensity distributions observed among eggs subjected to different covering conditions, wherein “absorbance intensity” corresponds to the degree of dye penetration into the egg albumen (as measured spectrophotometrically at 640 nm). Notably, uncovered eggs-particularly those that were punctured using the needle-display markedly higher absorbance values, indicating substantial influx of the dye solution. By contrast, eggs sealed with the silicone-based covering exhibit much lower absorbance readings, demonstrating that this covering substantially reduces dye ingress. Even in instances where the silicone covering was punctured, the overall absorbance levels remained comparatively low, thus evidencing the covering's ability to impede dye migration despite perforation. In layman's terms, one can regard the silicone covering as acting much like a self-resealing patch over a vulnerable opening: although puncturing does compromise the shell to a certain extent, the silicone barrier nonetheless minimizes the pathways available for the dye to seep through, thereby preserving the interior of the egg against significant dye contamination.

### Multi-Field Imaging Incubator for Embryonic Monitoring

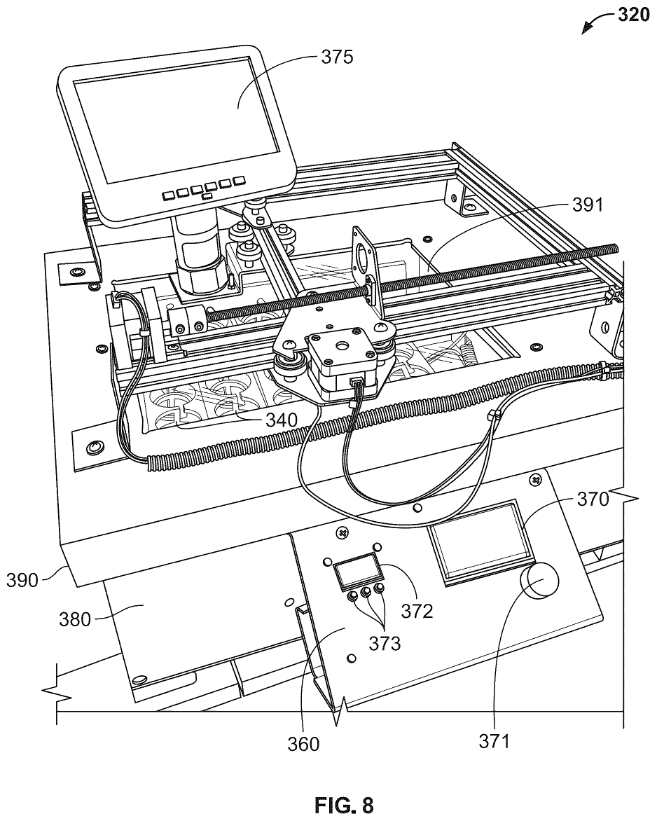

The Multi-field imaging incubator (MFii) shown in FIG. 8, is a dedicated system that integrates environmental control with dynamic spatial imaging capabilities for detailed monitoring of embryonic development. The MFii 320 provides stable incubation conditions while allowing continuous, high-resolution observation of eggs fitted with self-healing, transparent window coverings.

The core structure of the MFii can be built upon repurposed components from an Ender 3D printer. Specifically, the Z-axis is retained to control vertical movement with a resolution typically on the order of 0.05 mm per step, while the X-axis (in place of the original Y-axis) is employed for lateral positioning. This configuration enables precise repositioning of the imaging sensor relative to the eggs, ensuring accurate and repeatable focus across multiple samples. It can have a top 390 with a transparent window 391 constructed, for example, from tempered glass. The top surface preferable prevents condensation, thereby maintaining unobstructed optical access to the eggs. Tempered glass not also ensures that high-definition imaging is possible throughout the incubation period.

To maintain uniform temperature and humidity within the MFii, the internal chamber 380 can be insulated with foam material which can be wrapped in reflective film, such as car windshield film. This insulation minimizes heat loss and dampens external temperature fluctuations. A dedicated temperature regulation circuit can continuously adjust a heating coil output, while a Bluetooth-enabled relative humidity sensor can be used to monitor moisture levels and trigger water replenishment from a reservoir, which can be constructed, for example, from plastic milk jugs cut in half and joined at the necks. It was found that this maintained optimal relative humidity levels between 50% and 65%. This can be modified with custom manufacturing.

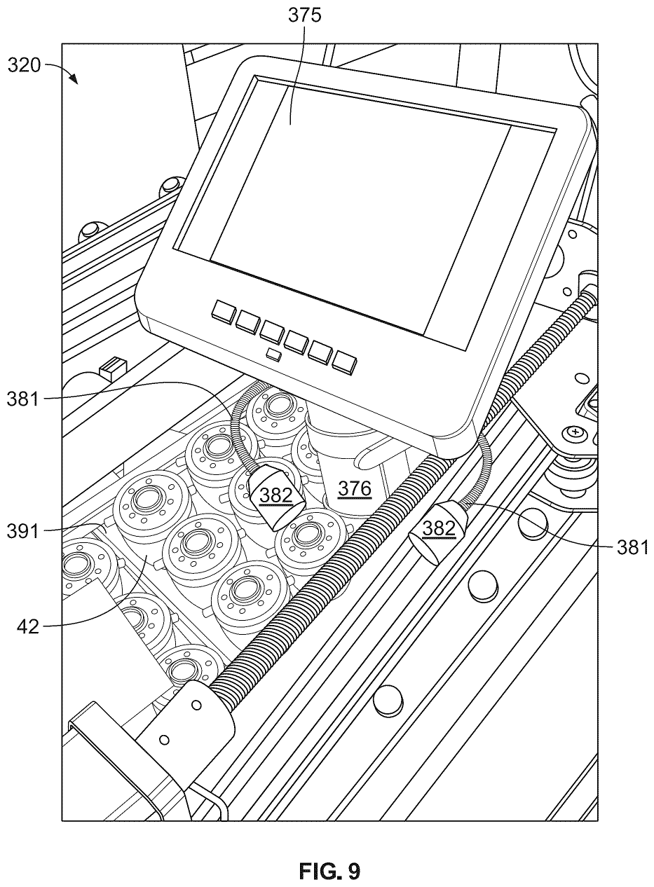

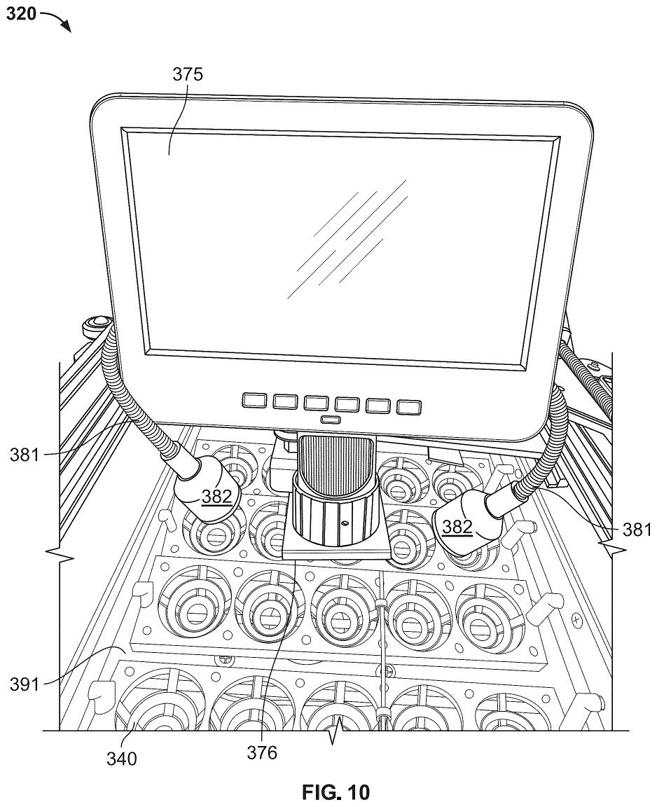

The MFii can include an integrated LED illumination system to provide lighting that is preferably uniform and nearly shadow-free. LED arms can be flexible, gooseneck-style mounts that house LED wiring within a bendable metal conduit. Each arm can be affixed directly to the XY gantry of the MFii, ensuring that the illumination remains stable and precisely positioned relative to the egg compartment. Moreover, each gooseneck arm can be set at an angle of 45° and 135° relative to the primary line of sight of the camera. FIG. 9 shows the LED arms. This angled arrangement minimizes glare from internal reflections—particularly those originating from the air cell membrane and the glass top, which are aligned at or near zero degrees with respect to the optical axis of the camera. By offsetting the LED arms in this manner, any reflected light is redirected away from the camera, thus preserving image clarity and maintaining the thermal equilibrium within the incubator. Referring to FIGS. 9 and 10, the MFii 320 has a display 375 interconnected with a camera 376. Additionally, the MFii 320 includes one or more LED arms 381 formed from a flexible, gooseneck conduit that can be bent or rotated to direct illumination precisely on an air-cell region of an egg. The LED head 382 is mounted at the tip of each arm 381 and contains an array of LEDs that provide bright, focused lighting. The bendable nature of the gooseneck arm 381 allows the user to adjust the lighting angle in real time without disturbing the incubator environment, ensuring that reflections and glare are minimized. LED wiring is routed internally through the conduit for a streamlined appearance and to reduce potential snag points within the incubator. The entire LED assembly can be secured to the incubator's frame or gantry, or interconnected with the display 375 or the camera 376 thereby maintaining a stable position relative to the camera and allowing uniform lighting conditions across multiple imaging fields.

The imaging module includes a high-resolution camera, such as, for example, a 24-megapixel camera, such as a camera from an electronic soldering microscope, which can offer approximately 100× magnification at a working distance of about 10 cm. It can be mounted on a movable platform that traverses the X-Y plane, ensuring that each egg can be individually and precisely brought into focus. This arrangement allows for the detailed capture of embryonic features such as vasculature, head, beak, and eye development.

For operational flexibility, the MFii can be equipped with both onboard storage and live transmission capabilities. A microSD card slot can be provided for a micro SD card, or another memory device can be utilized, for long-term image capture and data logging, while a microHDMI output can facilitate real-time monitoring on an external display 360. These features enable researchers to observe embryonic development continuously without the need to remove the eggs from the controlled environment.

Environmental monitoring within the MFii can be achieved through a network of digital temperature and humidity sensors distributed throughout the chamber. These sensors, which supplement the primary control circuit, continuously track internal conditions and provide data to the main control module. This module adjusts the heating coil, fan, and water reservoir input as necessary to maintain optimal conditions for embryonic growth. As shown in FIG. 8, Control panel 360 can include a display 370 for a position display and control 371, a display 372 for internal characteristics and controls 373.

The MFii can house a plurality of eggs 42 in egg baskets 340, such as up to 25 eggs simultaneously, each of which is fitted with a self-healing transparent air-cell cap (STACC) to maintain a sterile internal environment and allow unobstructed visualization of the vasculature of embryos. The combination of STACC caps with the MFii's stable and well-controlled environment allows for high-resolution, non-invasive imaging of embryonic development over extended periods.

The structural design of the MFii emphasizes modularity and replicability. The outer frame can be constructed from PVC and plywood components, which are assembled to form a robust, insulated enclosure. Components such as the LED illumination system, water reservoir, and electronic control units are integrated into the design to facilitate easy maintenance and future upgrades.

The MFii can also incorporate a user-friendly control interface that allows for precise adjustments of environmental parameters and camera positioning. The control module 360, housed within the MFii, or even in a dedicated compartment within the MFii, provides real-time feedback and manual override options for temperature, humidity, and imaging position, for maintaining optimal conditions throughout the incubation process.

In operation, the MFii enables continuous, high-resolution imaging of embryonic structures. By combining the stability of an optimized incubator with the dynamic spatial imaging provided by repurposed 3D printer components and high-resolution camera, the MFii supports detailed observation of embryonic vasculature and other developmental features. This system is particularly valuable for research in developmental biology, as well as for potential applications in biomedical and pharmaceutical fields, where non-invasive, real-time monitoring of embryo development is critical for cancer modeling experiments, where researchers could observe the growth and behavior of cancer cells within the embryonic egg environment.

Eggs were placed in both the MFII and a commercial incubator, with temperature and humidity monitored and recorded in both. The MFII's imaging equipment, including the electronic soldering microscope and LED illumination, provided real-time, high-resolution documentation of embryonic stages. Observations included the clarity of images and the stability of environmental conditions.

The comparison aimed to determine the effectiveness of the MFII in maintaining a stable environment and providing clear visibility compared to a traditional incubator. Data logging tools, such as an iPhone camera paired with sensors, were used for systematic recording of conditions and embryo development, helping to conclude on the incubator's capabilities for enhancing embryonic observation.

STACCed eggs, when placed in an MFII incubator, could allow for high-resolution, clear imaging of embryonic vasculature. Fertilized eggs of uniform size were selected, with initial viability confirmed through candling. Windows were created on the selected eggs using the drill windowing system, followed by the attachment of STACC caps using hot glue. These STACCed eggs were then placed in the MFII incubator, which was set to maintain optimal conditions for embryo development, specifically at 37.5° C. and around 60% relative humidity.

The MFII's imaging system was used to capture high-resolution images of embryonic vasculature through the STACC windows, with consistent lighting and positioning to ensure uniformity across all observations. Data was collected by documenting the clarity and resolution of the images, focusing particularly on the visibility of vascular structures. Imaging results from the MFII-incubated STACCed eggs were qualitatively assessed and used to provide proof of principle, supporting that embryonic air cell vasculature could be documented dynamically in an incubator environment.

Many of the components discussed and/or shown can be purchased on Amazon. Sterility of eggs and devices can be maintained by wiping down each individual egg and device (all parts in contact with the egg) with 70% ethanol and allowing them to air dry before use. Incubation can take place, and indeed did take place in experimentation described herein, at approximately 37.5° C. and 55% relative humidity. Fertile eggs used in experimentation and testing were purchased from the University of Connecticut Poultry Marketplace.

### Integrated Hyper-Customizable Egg Model System

An integrated system for creating hyper-customizable egg models for various in-ovo applications is provided. The system comprises three principal modules: (a) a window formation module for creating an access window in the eggshell, (b) a resealable covering module that provides a self-healing closure over the window, and (c) an imaging incubator module for continuous monitoring of embryonic development. Together, these modules form a unified platform that enables repeated sterile access to the egg interior while preserving embryo viability.

The window formation module may be implemented using either a CNC drill-based apparatus (DWAVE) or a rotation-based, horizontal laser ablation system (WAVE). In the DWAVE embodiment, an Ender 3 3D printer is repurposed so that its z-axis and y-axis motions, in combination with a ball-bearing carousel substituting for the conventional x-axis, sequentially present the egg to a drilling station, a vacuum decapping station, and a covering station. Alternatively, the WAVE embodiments (including S-WAVE for single eggs and Q-WAVE for multiple eggs) employ a horizontally oriented Class IV laser module mounted on a scissor-lift assembly with servo-driven rotation of the egg, thereby ablating a circumferential window near the air cell with high precision and minimal risk of penetrating the inner membrane.

The resealable covering module is exemplified by the 3D Printed Self-Healing Transparent Air-Cell Cap (STACC) system. A disposable base is affixed permanently around the pre-formed window, and a reusable cap—which could have a hyperboloid shape and incorporating a transparent coverslip—is attached to the base via a bayonet lock mechanism. The reusable cap includes access ports covered with self-fusing silicone tape that retains sealing properties even after repeated punctures (e.g., with a 14-gauge needle). This arrangement provides a clear, stable window for repeated interventions and imaging.

The MFii maintains precise temperature and humidity conditions while providing dynamic spatial imaging of the egg interior through the STACC. The MFii employs repurposed 3D printer components for precise X-Y positioning of a high-resolution camera, which is coupled with integrated LED illumination (with dual LED arms angled, for example, at 45° and 135° relative to the camera's line of sight) to minimize glare. The chamber, with a custom tempered glass top and insulated interior, maintains stable conditions (typically approximately 37.5° C. and 50-65% relative humidity) and enables continuous, non-invasive monitoring of embryonic development.

In operation, an egg is loaded into an egg support and processed using either the DWAVE SWAVE or QWAVE to form a precise window in the air-cell region. The window is then immediately covered to seal the interior against environmental contamination and water loss and a STACC cap applied. Finally, the egg is transferred into the MFii incubator, where the high-resolution imaging system continuously monitors embryonic structures through the transparent cap. The integration of these modules provides a reproducible, high-throughput process for creating egg models that are readily accessible for subsequent in-ovo interventions, including but not limited to early sex determination, transgenic modifications, cancer modeling assays, virus or biomolecule production, and nutritional fortification studies.

The modular design of the integrated system permits each module to be optimized independently while ensuring seamless interoperability. For instance, improvements in the CNC drill or laser ablation process (such as closed-loop feedback or enhanced position sensing) can be implemented without altering the STACC cap or MFii. Likewise, upgrades to the imaging system-such as the incorporation of fluorescent imaging capabilities-can be accommodated within the MFii without affecting the window creation or covering processes. This flexibility makes the integrated system highly adaptable to a range of research and industrial applications.

Having thus described the disclosure in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. An apparatus for creating a window in an egg comprising:
an egg support;
a drill assembly; and
a control for controlling movement of the drill assembly.

2. The apparatus of claim 1 further comprising a carousel for rotating an egg among multiple stations.

3. The apparatus of claim 2 further comprising a decapping station.

4. The apparatus of claim 2 further comprising a cover station to a film cover the window.

5. A method of creating a window in an egg comprising:
placing an egg in an egg support;
positioning the egg basket and egg under a drill;
drilling into the egg a desired depth;
controlling the depth of the drill with respect to the egg; and
removing debris.

6. The method of claim 5 further comprising placing a cover over the window.

7. An apparatus for creating a window in an egg comprising:
a rotating egg support;
a laser oriented horizontal to an egg; and
means for adjusting the position of the laser with respect to the egg.

8. The apparatus of claim 7 wherein the laser is supported on a scissor-lift driven by a servo motor.

9. The apparatus of claim 7 further comprising a camera.

10. A method of creating a window in an egg comprising:
positioning an egg in a rotating egg support;
actuating a laser horizontally with respect to a shell of the egg;
rotating the egg; and
ablating a region of the shell of the egg.

11. The method of claim 10 further comprising halting ablation before contacting an inner membrane of the egg.

12. The method of claim 11 further comprising adjusting a vertical position of the laser with respect to the egg.

13. The method claim 10 wherein a plurality of eggs are simultaneously ablated.

14. A cap assembly for an egg comprising:
a first part attached to an egg about an opening in a shell;
a second part detachably attached to the first part;
a transparent covering attached to the second part; and
a self-healing film over the opening.

15. The assembly of claim 14 wherein the second pat comprises a hyperboloid shape.

16. The assembly of claim 14 wherein a bayonet connection attaches the first and second parts.

17. The assembly of claim 14 wherein the self-healing film comprises a silicone-based tape.

18. A method of assessing the integrity of an egg-covering material using a dye ingress assay, the method comprising:
creating a window in an egg;
applying a covering material over the window;
attaching a scaffold around the window to form a well over the covering;
depositing a dye into the well;
permitting the dye to contact the covering for a predetermined interval;
collecting albumen from the egg and measuring dye concentration therein; and
measuring dye concentration in the albumen.

19. The method of claim 18, further comprising perforating the covering to simulate repeated access before depositing the dye solution.

20. An incubator for eggs, comprising:
a chamber with at least one transparent wall;
a temperature regulation system configured to maintain a target incubation temperature;
a humidity control system configured to maintain a defined range of relative humidity;
a camera mounted on a movable platform for capturing images of eggs within the chamber; and
an illumination system.

21. The incubator of claim 20, wherein the camera comprises magnification of at least 50× from a working distance of approximately 10 cm.

22. The incubator of claim 20, further comprising a microSD interface for local data storage and a microHDMI interface for live video output.

23. The incubator of claim 21, wherein the illumination system comprises dual LED arms attached to X-Y gantry of the camera.

24. The incubator of claim 21, further comprising supports for self-healing egg caps that allow repeated sterile access to the egg interior.

25. A method of dynamically imaging an avian egg in a controlled incubator environment comprising:
placing at least one egg, sealed by a transparent self-healing cap, into an incubator with adjustable temperature and humidity;
moving a camera along an X-Y platform to capture images of an interior of each egg through the cap; and
illuminating each egg with dual LED arms, enabling visualization of embryonic vasculature and structures.

26. An apparatus for creating a hyper-customizable egg model, the apparatus comprising:
a window formation module configured to create an access window in an avian egg by removing a predetermined portion of the eggshell adjacent to the air cell using a drill-based or laser-based system;
a resealable covering module comprising a disposable base and a reusable cap, the reusable cap including a transparent coverslip and self-healing material at one or more access ports; and
an imaging incubator module configured to maintain controlled environmental conditions and provide high-resolution imaging of the egg interior through the transparent covering.
